(19) United States
(12) Patent Application Publication
(10) Pub. No.: US 2005/0068595 A1
(43) Pub. Date: Mar. 31, 2005

(54) Holographic projection for grave memorial

(76) Inventor: Sean Fitzgerald, Ypsilanti, MI (US)

Correspondence Address: Barbara M. Burns, 1756 Plymouth Road #276, Ann Arbor, MI, 48105, US

(21) Appl. No.: 10/672,258

(22) Filed: Sep. 29, 2003

(51) Int. Cl. G03H 1/00; G02B 5/32

(52) U.S. Cl. 359/15; 359/1

(57) ABSTRACT

A system for conveying information about a deceased individual. The system employs a holographic projector for projecting 3-D visual information and an energy source for powering the holographic projector near to a grave marker or to an urn. Audible information can be delivered by a sound system. A memory slot can be used to change the information and an access door allows the system to be serviced. For a urn stored indoors, alternating current with an A/C adapter provides power. For outdoor use at a grave marker, a solar panel provides power (or A/C power can be used, if available). A switch may be used to operate the system and can be a proximity sensor to operate the system when a visitor approaches. Information can be changed by the use of a memory slot in the system.

### BACKGROUND OF THE INVENTION

The field of the invention relates to memorial markers for a deceased individual, such as for graves and urns. More particularly, the present invention relates to a system for a grave marker/headstone/gravestone for a deceased and/or an urn that contains crematorial remains. The system provides commemorative information concerning the deceased individual.

Since the earliest days, commemorative information about a deceased individual has been sought to be placed near the resting place of the deceased individual. Etching has been placed on a gravestone or a plaque added to the gravestone or to an urn to commemorate the life of a deceased. Generally, the information available in this manner has been basic factual information such as the date of birth of the individual and the date of death of the individual. For bereaved persons seeking to give more information about the deceased individual, options have been limited. Thus, a better solution to this problem was needed.

### SUMMARY OF THE INVENTION

The invention is a system for a grave marker or for an urn to memorialize a deceased individual. The system has equipment that can be part of a gravestone or part of an urn. The system includes an electrical system for displaying a holographic image of a deceased. The holographic image may be 3-D and is projected onto the ground, into the air in the vicinity of the grave or the urn. 3-D holography employs diffracted light from a laser-illuminated digital micro-mirror devices (DMDs). A virtual image in 3-D is created at a finite distance.

A solar energy panel or conventional electric source can power a battery or a capacitor to operate the system for use with a grave marker. In the case of an urn, which may be displayed in a home environment, conventional 110-volt electric power may be used as the power source with an A/C adapter to step the power down as needed. A solar panel could be positioned on the stand on which an urn is placed for use as a back-up power system.

Because the holographic image appears to have three dimensions, the image of the deceased seems to have physical substance. The addition of sound heightens the sensation.

The image displayed can be captured in a digital format from an existing photograph or a home movie. The individual may wish to record the memorial prior to the individual's passing. The image can be revised through a memory slot provided to the system and accessible through an access panel. A switch may be used to operate the system. A proximity sensor could also be used to operate the system when a visitor approaches.

Audible information can also be conveyed by the use of a sound file and a speaker. The deceased's voice and a music background could be advantageously employed herein. Inspirational messages/readings could be used also. A memory card/slot allows the information to be changed.

It is advantageous to the bereaved of the deceased individual to have comfort provided due to such as this invention. This invention can remind the bereaved of the loved one.

It should be noted that the device of the invention provides commemorative information to a viewer of the grave marker or the urn. This access afforded by this invention provides solace to the bereaved. No effort is required by a bereaved to view or hear the information if a proximity sensor is employed. Moreover, owners of deceased pets can beneficially employ this invention as a memorial.

For a more complete understanding of the present invention, reference is made to the following detailed description when read with in conjunction with the accompanying drawings wherein like reference characters refer to like elements throughout the several views, in which:

### BRIEF DESCRIPTION OF THE DRAWINGS

FIG. 1 illustrates an environmental view of the system in conjunction with a funerary urn for displaying an image;

FIG. 2 illustrates an partial view of a holographic projector creating an image on a virtual panel; and

FIG. 3 illustrates the system used in conjunction with a grave marker having solar panels for powering the device.

### DESCRIPTION OF THE PREFERRED EMBODIMENTS

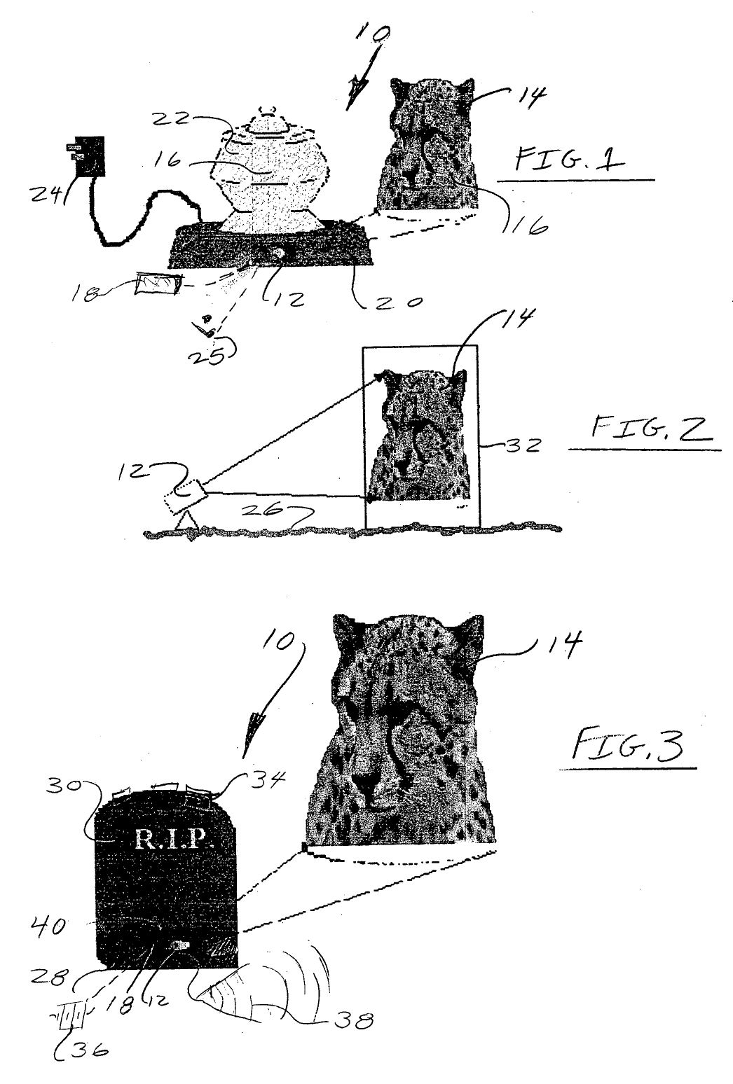

Now turning to the drawings, the system 10 for conveying information about a deceased individual is thereshown in FIGS. 1 through 3. Holographic projector 12 projects image 14 of deceased individual 16 stored in memory 18 as shown in FIG. 1. Holographic projector 12 is contained within base 20. Funerary urn 22 contains the remains of individual 16. Funerary urn 22 is placed on base 20. Image 14 can be 3-D and holographic projector 12 is powered by A/C current through A/C adapter 24. The power source can be household current. Switch 25 operates the system and can be a proximity sensor (not shown) to operate the system when a visitor approaches.

Now turning to FIG. 2, holographic projector 12 is better shown as being at a ground level 26 thereby indicating a position near the base 28 of gravestone 30 (better shown in FIG. 3). Holographic projector 12 projects image 14 onto virtual hologram panel 32.

System 10 is depicted with gravestone 30 in FIG. 3. Solar panel 34 (or multiple solar panels 34 as is needed to power system 10) is positioned on the gravestone 30 to receive solar energy to power system 10. Battery 36 stores solar energy from solar panel 34 for operating system 10. Speaker 38 delivers audible information. Speaker 38 is powered by energy from solar panel 34. Access panel 40 allows access to holographic projector 14 and to memory card 18 for revisions to information.

1. A system for conveying information about a deceased individual, the system comprising
one of a holographic projector for projecting visual information and an audible projector for delivering audible information about a deceased individual,
an energy source for powering at least one of the holographic projector and the audible projector, and
a circuit connecting the energy source to one of the holographic projector and the audible projector.

2. The system for conveying information about a deceased individual according to claim 1, further comprising one of a switch for controlling the system, a power collecting device, a power storage device, and a memory slot for updating information to be displayed about the deceased individual.

3. The system for conveying information about a deceased individual according to claim 1, wherein one of the holographic projector and one of the audible projector being positioned in one of near to and on one of a grave marker and an urn.

4. The system for conveying information about a deceased individual according to claim 1, the information projected by the holographic projector being a hologram projected into a space around the grave marker and the information projected by the audible projector being audible information.

5. The system for conveying information about a deceased individual according to claim 2, the information projected by the holographic projector being a hologram projected into a space around the urn.

6. The system for conveying information about a deceased individual according to claim 1, the information being projected by the holographic projector being a 3-D image.

7. The system for conveying information about a deceased individual according to claim 3, the urn having a base, and one of the holographic projector and the audible projector being positioned within one of the grave marker and the base of the urn.

8. The system for conveying information about a deceased individual according to claim 7, wherein protection from elements of nature is provided to one of the holographic projector and the audible projector by positioning one of the holographic projector and the audible projector within one of the grave marker and the base of the urn.

9. The system for conveying information about a deceased individual according to claim 7, further comprising an access door for servicing the system.

10. The system for conveying information about a deceased individual according to claim 1 wherein the energy source for powering the system being an alternating current.

11. The system for conveying information about a deceased individual according to claim 10 further comprising an A/C adapter.

12. The system for conveying information about a deceased individual according to claim 1 wherein the energy source for powering the system comprises at least a solar panel.

13. The system for conveying information about a deceased individual according to claim 1, wherein the information about a deceased can be an image of the deceased individual.

14. The system for conveying information about a deceased individual according to claim 13, wherein the image of the deceased individual can be generated from a preexisting image.

15. The system for conveying information about a deceased individual according to claim 14, wherein the image of the deceased individual can be generated from one of a photograph and a video.

16. The system for conveying information about a deceased individual according to claim 1, further comprising a sound delivery system for delivering audible information.

17. The system for conveying information about a deceased individual according to claim 15 wherein audible information is provided by at least one speaker.

18. The system for conveying information about a deceased individual according to claim 15 wherein the audible information can be one of the earlier captured voice of the deceased individual and music and inspirational readings.

19. The system for conveying information about a deceased individual according to claim 2 wherein the switch comprises a proximity sensor.
